(19) United States
(12) Patent Application Publication
(10) Pub. No.: US 2005/0072823 A1
(43) Pub. Date: Apr. 7, 2005

(54) Article storage basket incorporated into a handlebar steering assembly

(76) Inventor: Steven Lee Boehmke, Orange, CA (US)

Correspondence Address: Erik M. Arnhem, P.O. Box 480274, Los Angeles, CA, 90048, US

(21) Appl. No.: 10/678,912

(22) Filed: Oct. 6, 2003

(51) Int. Cl. B62J 7/06

(52) U.S. Cl. 224/420

(57) ABSTRACT

A bicycle or similar vehicle having a handlebar steering mechanism can be equipped with a safe reliable support mechanism for an article-storage basket located above the front wheel. Two rigid tubular arms extend forwardly from the handlebar steering mechanism to provide permanent welded connections to an article storage basket. The high strength weld connections overcome shortcomings of clamps and strut assemblies that are conventionally used to mount an article-storage basket on a bicycle.

### FIELD OF THE INVENTION

This invention relates to a vehicle handlebar steering mechanism that includes permanent attachments for an article-storage basket. The invention can be utilized in various vehicles having handlebar type steering mechanisms, e.g. bicycles, tricycles, motorcycles, and scooters.

### BACKGROUND OF THE INVENTION

To enhance the usefulness of pedal-operated bicycles, it has been a common practice to mount article-storage baskets on the bicycle handlebars over the bicycle front wheel. Usually the basket has been attached to the handlebars by means of two bolt-operated clamps located equidistant from a central point on the handlebar.

Such clamps have a tendency to slip on the curved handlebar surface, especially when the basket is fully loaded, or when the bicycle is subjected to vibrational forces (e.g. operating on rocky or rough terrain). To augment the basket-support action of the clamps, ancillary struts were often added underneath the basket. Each strut extended downwardly from the basket bottom wall to the lower end of the front wheel fork, such that the weight of the loaded basket was partially transmitted through the struts to the fork.

The support struts have proved to be successful as basket-support devices. However, they cannot be employed with some wheel fork constructions, e.g. fork structures having built-in wheel suspensions (shock absorbers). Resilient wheel suspensions in the wheel forks cause the upper and lower sections of the fork to slide or telescope relative to one another, to achieve the wheel suspension movement. As a result, the lower end of the fork moves up and down relative to the article-storage basket, so that it is not practical to connect rigid struts between the basket and the lower end of the front wheel fork.

There is a need for an improved method of supporting an article-storage basket above the front wheel of a bicycle, tricycle, motorcycle or scooter, without using supporting struts between the basket and the front wheel fork.

### SUMMARY OF THE INVENTION

The present invention relates to a safe, reliable method for supporting an article-storage basket above the steerable front wheel of a bicycle, without using struts that extend from the basket to the lower end of the front wheel fork structure.

In preferred practice of the invention the article-storage basket is permanently supported on the vehicle (e.g. bicycle) steering mechanism by means of two laterally-spaced arms extending between the steering mechanism and the basket. Each arm has a first permanent (welded) connection to the steering handlebar, and a second permanent (welded) connection to the basket. The arms rigidly join the basket to the handlebar, so that the basket and handlebar constitute one integral structure having a high resistance to breakage or failure under high loadings on the basket.

The invention avoids the shortcomings of clamps and support struts which have heretofore been used to support the article storage basket.

Specific features of the invention will be apparent from the attached drawing and description of an illustrative embodiment of the invention.

### BRIEF DESCRIPTION OF THE DRAWINGS

FIG. 1 is a side elevational view of a bicycle having an improved basket-support mechanism constructed according to the invention.

FIG. 2 is a fragmentary plan view of the FIG. 1 bicycle-basket structure, taken in the direction of arrow A in FIG. 1.

FIG. 3 is a fragmentary enlarged sectional view of a basket-support structure used on the FIG. 1 bicycle. FIG. 3 is taken on line 3-3 in FIG. 2

FIG. 4 is a sectional view taken in the same direction as FIG. 3, but illustrating another basket-support structure embodying the invention.

FIG. 5 is a plan view of the FIG. 4 structure, taken in the direction of arrow B in FIG. 4.

### DESCRIPTION OF A PREFERRED EMBODIMENT OF THE INVENTION

Referring to FIG. 1, there is shown a bicycle that includes a frame 10, rear wheel 12, front wheel 14, and seat 16. The bicycle has a manual propulsion system that includes a front sprocket 18, rear sprocket 20 connected to rear wheel 12, and drive chain 22 trained around the sprockets. Pedal assemblies 24 are operatively connected to sprocket 18, whereby a person seated on seat 16 is enabled to propel the bicycle, in conventional fashion.

Frame 10 includes a head tube 26 that rotatably mounts a tubular stem 28 for rotation around the stem axis 30. The lower end of stem 28 is rigidly attached to a fork structure 30 that rotatably connected to the axle 32 of front wheel 14. Incorporated into each leg of fork structure 30 is a resilient wheel suspension 34, that may be either a coil spring suspension or an air suspension.

The upper end areas of fork structure 30 are slidably telescoped on the lower end areas of the fork structure, so that front axle 32 is enabled to move up or down in response to road surface irregularities. Wheel suspension 34 is conventional in the bicycle art.

In a typical bicycle, head tube 26 carries an upper ball bearing assembly and a lower ball bearing assembly, whereby stem 28 is enabled to freely turn around stem axis 30 so as to vary the rotational plane of front wheel 14, to thus steer the vehicle. Handlebars 36 are operatively connected to stem 28, whereby a person seated on seat 16 can move the handlebars to the right or to the left, to effect a desired steering action.

FIG. 3 generally one way that the handlebars can be connected to stem 28 (not visible in FIG. 3, but shown in FIG. 1). A tubular member 38 extends forwardly from stem 28 to support a clamp member 40 (welded to member 38). Handlebars 36 include a transverse central bar (or tube) 42 that is in grip contact with clamp member 40. A mating clamp member 44 is biased toward clamp member 40 by means of bolts 46, such that bar 42 is gripped by the clamp assembly, to thereby hold the handlebars 36 in a fixed orientation relative to tubular member 38 (and stem 28).

The clamp assembly can be loosened (by untightening bolts 46) to permit an angular adjustment of handlebars 36 around the axis of transverse bar, as indicated by arrows C in FIG. 1. During normal operation of the bicycle, the clamp assembly is in a grip condition on transverse tube 42, so that the handlebars are fixed relative to stem 28.

The present invention relates particularly to an article-storage basket 48 located above the bicycle front wheel forwardly from the bicycle steering mechanism (i.e. handlebars 36). A principal feature of the invention concerns the mechanism for attaching basket 48 to the steering mechanism (using permanent welded connections instead of clamps).

As shown in the drawing, basket 48 comprises an endless tubular rim 50 that forms an upwardly-open mouth for the basket front wall 56, rear wall 58, and side walls 60 of the basket have their upper edges welded to the undersurfaces of tubular rim 50. Bottom wall 62 of the basket is welded to the lower edges of walls 56, 58 and 60. Holes 64 can be formed in walls 56, 58 and 60 to lighten the basket, and to permit air flow through the basket (to reduce air flow resistance).

Basket 48 is attached to handlebars 36 by two laterally spaced tubular arms 62 extending between rim 50 and central tube 42 (that forms part of the unitary handle-bar mechanism). The tubular arms 62 are widely spaced to provide a wide stance support for the basket.

The rear end of each tubular arm 62 has a permanent welded connection to central tube 42 of the handlebar mechanism. The front end of each tubular arm 62 has a second permanent welded connection to rim 50 of basket 48. The basket and handlebar mechanism thereby constitute one integral structure that is highly resistant to breakage or distortion under high load conditions. The tubular nature of rim 50 provides a relatively large surface for the weld connections to arms 62, so that breakage of the weld connections is precluded.

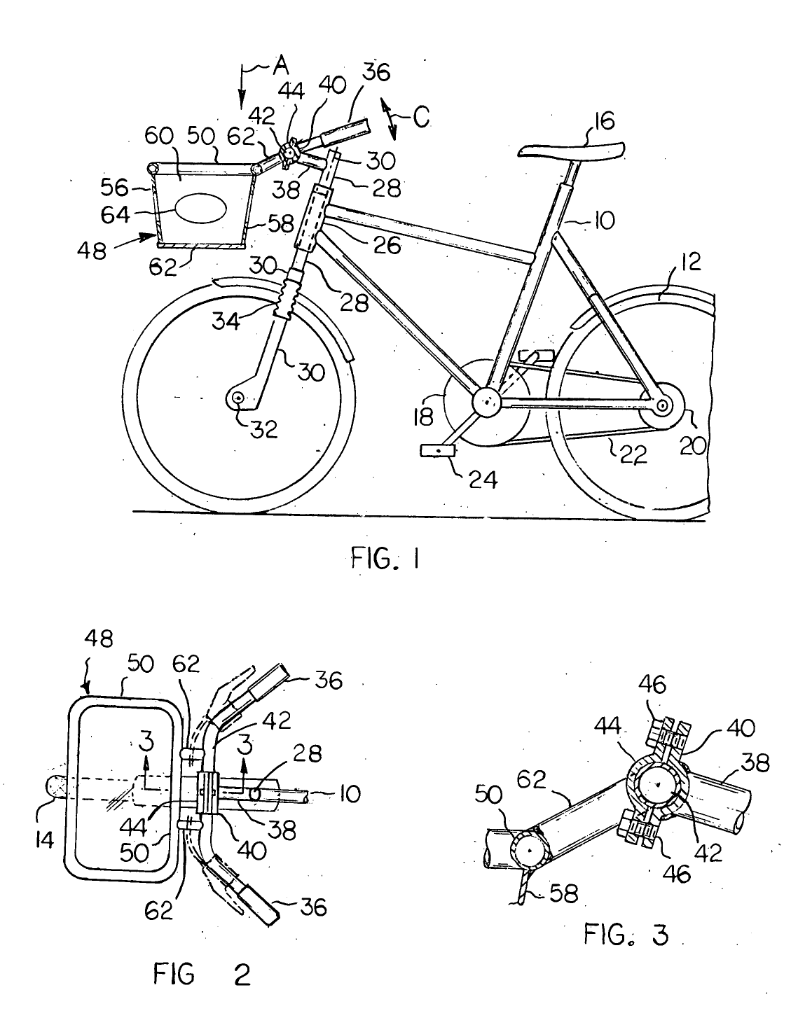

Each tubular arm 62 has an appreciable length (e.g., two inches or greater), such that the basket rear wall 58 is spaced an appreciable distance forwardly from the transverse central bar 42, as shown in FIG. 2. The free space between the basket rear wall and central bar 42, as shown in FIG. 2. The free space between the basket rear wall and central bar 42 can be used to accommodate conventional brake cables for the front and rear wheels. Typically, the space between the basket rear wall and central bar 42 will be such that the basket rear wall is located directly above the front wheel axle 32 (that defines the wheel rotational axes).

FIG. 2 shows in phantom lines two brake cables and associated cable actuator assemblies mounted on handlebars 36. The cables extend from the actuator assemblies downwardly through the free space defined by tubular arms 62, so that the cables are confined against undesired back and forth movements.

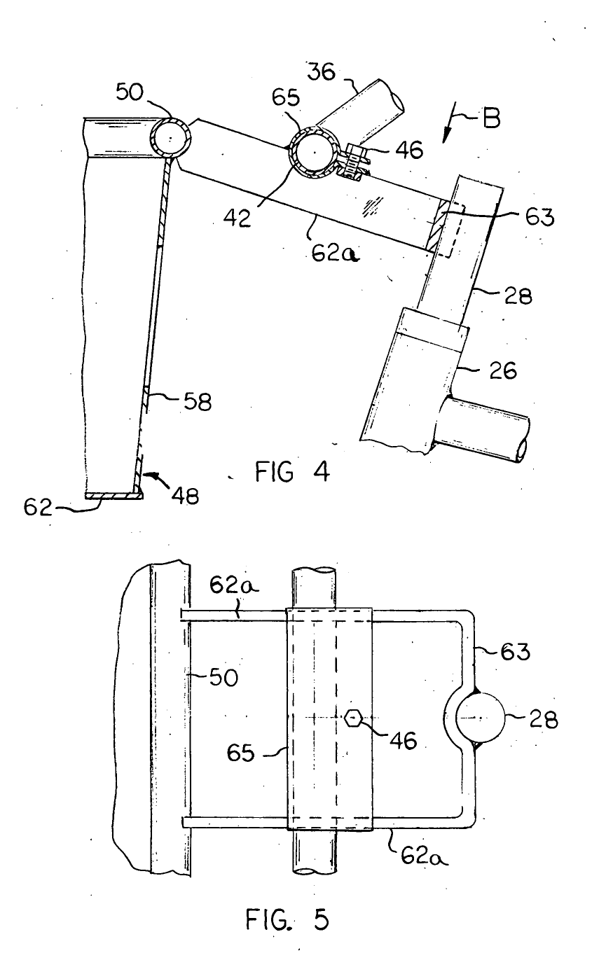

FIGS. 1 through 3 show a preferred form of the invention. However, the invention can take other forms, as shown e.g. in FIGS. 4 and 5. As there shown, two rigid arms 62a are an integral part of a high strength channel member 63 that is welded to stem 28. The forward ends of arms 62a are permanently welded to tubular rim 50 of the basket, so that the basket is rigidly secured to the vehicle steering mechanism.

In the FIG. 4 arrangement arms 62a serve as mounts for a clamp 65 that is designed to grip the central transverse tube (bar) 42 of handlebar mechanism 36. One or more bolts 46 are used to provide the necessary clamp force on tube 42.

The mechanism depicted in FIGS. 4 and 5 differs structurally from the mechanism shown in FIGS. 1 through 3 but still offers the same advantages, namely a rigid permanent mounting for basket 48 on the vehicle steering mechanism.

The drawings show the invention applied to the steering mechanism of a bicycle. However, the invention can be used on other vehicles equipped with handlebar steering mechanisms, e.g. tricycles, motorcycles, or scooters.

1. In a wheeled vehicle that includes a frame, a front wheel, and a manual steering means rotatably connected to said frame for varying the rotational plane of said front wheel, the improvement comprising:
an article storage basket located above said front wheel; and rigid support means permanently securing said basket to said manual steering means; said rigid support means comprising two laterally spaced arms extending between said steering means and said basket; each said arm having a first permanent connection to the steering means and a second permanent connection to the basket.

2. The improvement of claim 1, wherein each said arm is tubular.

3. The improvement of claim 1, wherein each said connection is a welded connection.

4. The improvement of claim 1, wherein the manual steering means comprises a set of handlebars joined to a transverse central bar; said laterally spaced arms extending between said transverse bar and said basket.

5. The improvement of claim 4, wherein each said arm is tubular.

6. The improvement of claim 4, wherein each said connection is a welded connection.

7. The improvement of claim 4, wherein said basket has a front wall, rear wall, two side walls, and a bottom wall;
each said arm having a length such that the basket rear wall is spaced an appreciable distance forwardly from said transverse central bar.

8. The improvement of claim 7, wherein the basket rear wall is located directly above the front wheel rotational axis.

9. The improvement of claim 1, wherein said basket comprises an endless tubular rim that forms an upwardly-open mouth for the basket; said laterally spaced arms being joined to said tubular rim via said second permanent connections permanent connections.
